(19) United States
(12) Patent Application Publication
(10) Pub. No.: US 2015/0018731 A1
(43) Pub. Date: Jan. 15, 2015

(54) LEVERAGE ENHANCED TRIGGER POINT MASSAGE DEVICE

(71) Applicant: James R. La Peer, Wilton, NH (US)

(72) Inventor: James R. La Peer, Wilton, NH (US)

(21) Appl. No.: 14/326,681

(22) Filed: Jul. 9, 2014

Related U.S. Application Data
(60) Provisional application No. 61/844,901, filed on Jul. 11, 2013.

(51) Int. Cl. A61H 39/04

(52) U.S. Cl. CPC A61H 39/04
USPC 601/135

(57) ABSTRACT

A tool uses leverage, gravity, and/or lower body strength to apply enhanced deep pressure to trigger points and other distressed muscles while minimizing user effort. A cord extending from at least one end of a generally hook-shaped main body tethers the end to an external structure such as a chair or door knob, or the user's foot, while a pressing segment is placed against the trigger point. The untethered end is then manipulated to create leveraged pressure, or the user leans away or extends a leg to apply gravitational pressure or lower body strength. The pressing segment can include a fixed or removable pressing knob. In embodiments the pulley cord extends from both ends of the main body, and some embodiments include exchangeable pressing segments for reconfiguration between pressing on distributed regions and/or applying focused pressure to specific locations, and for switching between leverage, gravity, and lower body strength enhancement.

### RELATED APPLICATIONS

This application claims the benefit of U.S. Provisional Application No. 61/844,901, filed Jul. 11, 2013, which is herein incorporated by reference in its entirety for all purposes.

### FIELD OF THE INVENTION

The invention relates to massage devices, and more particularly, to devices for applying ischemic compression and stretching to trigger points and other muscle areas by a user without assistance.

### BACKGROUND OF THE INVENTION

Tender spots in taut bands of muscles are sometimes referred to as “trigger points,” a term that was first coined in 1942 by Janet G. Travell, MD, a noted pioneer in the field of myofascial pain and dysfunction. These tender spots may occur actively in the affected muscle, produce additional tender spots, or refer pain to other muscles in the body. “Trigger points,” technically speaking, are areas of cells in the muscle where blood flow has been reduced, and cellular metabolic wastes aren't being exchanged for oxygen and nutrients. If enough trigger points are located together, these form the “knots” that can be felt when they are being pressed.

Although pain is a common symptom of trigger points, these muscle knots can exist painlessly, in latent form, to cause other types of dysfunction such as tightness, spasm, and weakness. Sometimes it only takes a cold draft, repetitive motion, or even a minor trauma to turn a painless trigger point into a source of pain.

A trigger point may feel like a hard “lump,” knot or band in the muscle. Or it may occur as broad muscle soreness. Applying deep pressure to the muscle, either in a localized, focused manner or more broadly across the affected area, almost always alleviates pain, even though the pressure itself can be somewhat uncomfortable when applied. In many cases, flexibility and range of motion can also be improved.

Of course, trigger points are not the only source of muscle discomfort or pain that can be relieved by pressure. Throughout their lifetimes, many people experience some muscle pain and discomfort. This pain and tenderness may be a direct result of injury or disease or it may have occurred following a strenuous sport activity, or as a result of lifting or repetitive work.

Trigger points and other types of muscle tightness and pain can vary widely in location. Often, they occur in the back, shoulders, or other areas that the person experiencing the discomfort cannot directly reach. Nevertheless, it may be desirable for a person suffering such discomfort to apply pressure to the affected area without the assistance of others. In such cases, a tool or device is sometimes used to allow a person to apply pressure to such inaccessible areas of his or her own body.

Devices for allowing a user to massage or manipulate back muscles without assistance are known in the prior art. Examples of such devices include U.S. Pat. Des. 403,431 (Gladieux, 1998), U.S. Pat. No. 5,530,983 (Maltese, 1996), U.S. Pat. Des. 382,644 (Chi, 1997), U.S. Pat. No. Des. 317,204 (Henneseey, 1991), U.S. Pat. Des. 326,721 (Ujifusa and Stewart, 1992), U.S. Pat. No. 4,798,198 (Wright, 1989), U.S. Pat. Des. 268,362 (Wong, 1983), and U.S. Pat. No. 4,266,536 (Casares, 1981).

FIG. 1A is a side view of one such prior art tool. The tool is essentially a hooked rod or tube 100 terminated on at least one end by a knob 102. As is shown in FIG. 1B, a user holds the shaft portion of the “cane” with the hooked portion positioned behind the shoulder, and pulls the cane downward and away from the body 104, driving the knob 102 into the shoulder muscle trigger point.

FIG. 2A is a side view of a similar tool 100 (see U.S. D403,431 to Gladieux) that has essentially an S shape. The tool is terminated at both ends by knobs 202, and with reference to FIG. 2B is used in a manner similar to FIG. 1B, except that the pushing motion 204 is more directly away from the user's body. The tool shown in FIGS. 2A and 2B can be separated at a central junction 206 for easy transportation and storage.

FIG. 3A is a perspective view of yet another prior art tool 300 (see U.S. D317,204 to Henneseey) used to apply pressure to trigger points on the user's back without assistance. This tool 300 includes a plurality of knobs at various locations 304, including some that are on extensions 302. The extensions allow for access to regions that are even more difficult to reach, and also serve as handles when the tool 300 is used at certain angles. A similar tool is shown in use in FIG. 3B, with a force 308 being applied to the shaft downward and away from the user.

FIG. 4 illustrates yet another tool that is used in the prior art for applying pressure to trigger points on a user's back. In this case, the tool 400 is sufficiently long for one end 404 to rest on the ground (braced by the user's foot). The hooked end is placed behind the user's back, and the tool is pivoted about the end that is on the ground, with the user pushing the shaft almost directly away from herself.

Unfortunately, the use of these tools requires application by the user of considerable force, which may be beyond the strength limits of many users. As a result, the pressure that is applied is often insufficient to provide the maximum relief. Also, the benefits of pressure applied to a trigger point or other distressed muscle area are greatest if the distressed muscle is as relaxed as possible. However, it can be difficult for a user to tense one muscle group while trying to relax another muscle group. As a result, attempts to apply sufficient force may cause the user to tense his or her muscles in the affected area, thereby reducing the benefits of the applied pressure, and possibly risking injury.

One approach is to focus the applied force as much as possible in a small region. All of the prior art examples presented in FIGS. 1A through 4 use knobs to focus the applied force. However, this focusing effect may still be insufficient to provide the desired force. In addition, trigger points and other types of muscle distress can sometimes derive greater benefit with less discomfort to the user if the tissue can be manipulated in a broad area all at one time.

What is needed, therefore, is a tool that enables a user, without assistance, to apply deep pressure to distressed muscles, including muscles in inaccessible body regions, while minimizing the amount of force that the user must exert to achieve a desired degree of pressure.

### SUMMARY OF THE INVENTION

A tool for applying deep pressure to trigger points and other distressed muscles utilizes leverage, gravity, and/or lower body strength to augment and/or supplement an unassisted user's physical effort, thereby enabling the user to apply increased pressure to trigger points and other distressed muscles with reduced user effort. The tool combines a generally hook-shaped main body with a pulley system that emerges from the main body at either or both of its proximal and its distal ends. The pulley is used to tether either end of the main body to a nearby structure or to the user's body (e.g. to the user's foot), while a pressing segment is placed against the affected muscle area. The user then manipulates the other end of the main body to apply leveraged force to the affected muscles, or leans away from the tethered end to apply gravitational force to the muscles. If the pulley is attached to the user's foot, the user can also utilize lower body strength by extending his or her leg and applying pressure to the affected region, thereby increasing the available force and decreasing the required effort, because lower body strength is typically much greater than upper body strength.

In various embodiments, when using leverage to apply pressure to the upper back or shoulder or to the front of the upper leg, the proximal end of the tool can be anchored by the pulley to the user's foot or to a leg of a chair or some other anchor point. A pressing region of the pressing segment is placed against the distressed muscle area, and the user then applies a levering force to the distal end of the main body, thereby applying pressure to the distressed muscle group with a force that is greatly amplified by leverage as compared to the muscle effort exerted by the user.

In some embodiments, the pressing segment is configured to apply leverage-enhanced pressure over an extended area of the user's body, while in other embodiments the pressing segment includes a pressing knob that applies leverage-enhanced, focused pressure to a small area. In similar embodiments, the pressing segment includes a mounting hole to which a separate pressing knob can be mounted, thereby allowing the same tool to be used for applying both diffuse and locally focused pressure. In yet other embodiments the hooked proximal end of the main body is terminated by a pressing ball, so that the tool can be used to apply gravitational force to affected areas.

When applying gravitational force, for example to the lower back, the user anchors the distal end of the main body to a nearby structure using the pulley system and places the focusing knob against the distressed muscle group. The user then simply leans away from the structure and uses his or her weight to apply pressure to the desired muscle region.

Depending on the area where the pressure is to be applied, the user can also anchor the distal end of the tool to his or her foot, place the pressing knob of the gravitational segment against the desired muscle group, for example near the top of a shoulder, and use his or her leg muscles to apply the desired pressure, thereby making use of the significantly greater strength available from leg muscles as compared to arm and shoulder muscles.

In embodiments, the hooked portion of the main body has a circular shape with a radius of between 4 and 7 inches. In other embodiments, the hooked portion of the main body has an elliptical shape with a long axis of between 8 and 14 inches. In various embodiments, an overall length of the main body is between 1.5 and 3 feet.

In embodiments, elements of the invention are made from metal tubing, plastic tubing, wood, fiberglass, aircraft strength aluminum tubing, carbon fiber, and/or injection molded plastic. In certain embodiments the main body can be separated into at least two parts for transportation and storage.

The pulley system includes a cord or “Tension Control Element” which in various embodiments is made from rope, wire cable, plastic cord, and/or chain. In some embodiments the tension control element passes through the center of the main body of the device, while in other embodiments it is anchored to the top, bottom, and/or sides of the device, or woven through a handle from side to side or up and down.

In embodiments, the Tension Control Element is a rope or a series of knots, chain, nylon strapping, nylon webbing ¼″ to 1″ wide and up to ¼″ thick, or friction binding. In various embodiments, a wedge or a screw is attached to the Tension Control Element, whereby a hook is attached to allow a user to attach the Tension Control Element to a chair or a stool that they are sitting on, to the hinge of a door or a door knob (e.g. when the individual is in a standing position), or under the user's foot.

In some embodiments, the Tension Control Element is fixed to one end of the main body, in either an adjustable or a non-adjustable manner. In other embodiments, the Tension Control Element extends along or through the entire main body, and emerges from both ends. In some of these embodiments, a locking mechanism is included for fixing the position of the Tension Control Element relative to the main body. The locking mechanism can include a bolt, a wedge for binding, and/or a friction slide that restricts movement of the Tension Control Element.

Depending on the embodiment, the locking mechanism can be made from nylon rope, nylon webbing, hooks, or clamps.

In certain embodiments of the present invention a kit includes separate tools for applying leverage-enhanced and gravitationally enhanced force. In other embodiments, a kit includes a single main body and a plurality of exchangeable pressing segments that can be interchanged to enable application of either leverage-enhanced or pressure-enhanced force over either a distributed area or a localized, focused area.

The present invention is a tool for unassisted application by a user of deep pressure to a distressed muscle area of the user's body. The tool includes a main body having a substantially straight section terminating in a distal end and a curved section terminating in a proximal end, a pulley cord cooperative with the main body and extending beyond at least one of the distal end and the proximal end of the main body, the pulley cord being constrained to remain proximal to the main body at least near one of the main body's distal and proximal ends, a pulley locking mechanism configured to fix the position of the pulley cord relative to the main body, and a pressing segment attached to the main body near its proximal end. The pressing segment has a pressing feature, and the main body, pulley cord, pulley locking mechanism, and pressing segment are configured for anchoring by the pulley cord of the distal or the proximal end of the main body to the user's foot or to an external structure and placing the pressing feature against the distressed muscle area, thereby enabling a pressing force to be applied to the distressed muscle area, the pressing force being enhanced by at least one of leverage, gravity, and the user's lower body strength.

In embodiments, the main body is separable into at least two parts.

In some embodiments, at least some portion of the tool is made from metal tubing, flat metal stock, plastic, wood, fiberglass, aircraft strength aluminum, or carbon fiber. In other embodiments, the pulley cord includes at least one of rope, wire cable, plastic cord, a series of knots, nylon strapping, nylon rope, nylon webbing, friction binding, chain hooks, and clamps.

In certain embodiments the pulley cord passes through the center of the main body. In various embodiments, the pulley cord is anchored to at least one of a top, a bottom, and a side of the main body. In exemplary embodiments the pulley cord is woven through a handle of the main body from side to side or up and down.

Embodiments further include a wedge or a screw attached to the pulley cord, whereby a hook is attached to the pulley cord to allow the user to attach the pulley cord to a portion of the user's body or to a nearby structure.

In various embodiments, the pulley locking mechanism includes at least one of a bolt, a wedge for binding, and a friction slide that restricts movement of the pulley cord. Certain embodiments further include a handle attached to the main body, the handle being configured to allow a user to hold and stabilize the main body with one hand while using the tool to apply pressure to the distressed muscle area.

In some embodiments, the pressing segment includes a mounting mechanism for a removable pressing knob.

In various embodiments, the pressing segment is removable from the main body and exchangeable with at least one other pressing segment. In some of these embodiments at least one of the pressing segments is attachable to the proximal end of the main body. In other of these embodiments at least one of the pressing segments is simultaneously attachable to at least two separated locations on the main body. In certain of these embodiments, the pressing feature of at least one of the pressing segments is a region of substantially uniform width extending from a first end of the pressing segment to a second end of the pressing segment and transitioning smoothly in direction there between through an angle of approximately ninety degrees. In various of these embodiments, the pressing feature of at least one of the pressing segments is a rounded knob. And in some of these embodiments at least one of the pressing segments extends from a first end that is attachable to the proximal end of the main body to a second end that is terminated by a rounded pressing knob.

In embodiments, at least one end of the pulley cord is terminated by an attachment loop. In some embodiments, at least one end of the pulley cord is terminated by an attachment hook. Some of these embodiments further include an anchor assembly including a ring that is attachable to said attachment hook and a flat segment that is attached to said ring and configured for placement under a weighted object for anchoring of the ring thereto. And other of these embodiments further include an anchor assembly including a ring that is attachable to said attachment hook and a cord terminated at both ends by loops, said cord being insertable through said ring and being attachable by said end loops to a compatible structure for anchoring of the ring thereto.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1A is a side view of a first prior art device;

FIG. 1B is a perspective view showing the prior art device of FIG. 1A in use;

FIG. 2A is a side view of a second prior art device;

FIG. 2B is a perspective view showing the prior art device of FIG. 2A in use;

FIG. 3A is a side view of a third prior art device;

FIG. 3B is a perspective view showing the prior art device of FIG. 3A in use;

FIG. 4 is a perspective view showing a fourth prior art device in use;

FIG. 5A is a perspective view of an embodiment of the present invention that is configured for applying leverage-enhanced pressure that is either distributed or locally focused, shown in a distributed pressure configuration;

FIG. 5B is a perspective view of the embodiment of FIG. 5A, shown in a locally focused pressure configuration;

FIG. 5C is a perspective view of an embodiment of the present invention that is configured for applying locally focused gravity-enhanced pressure;

FIG. 5D is a side view of an embodiment of the present invention that includes exchangeable pressing sections for applying both distributed and locally focused pressure that is either leverage-enhanced or gravity-enhanced;

FIG. 6A is a side view of the embodiment of FIG. 5A tethered to a chair leg and applying leverage-enhanced pressure to a shoulder of a user;

FIG. 6B is a close-up view of the tool of the Embodiment of FIG. 5D applied to the user's shoulder;

FIG. 6C is a front view showing the tool of FIG. 5D being applied to the upper leg of a user;

FIG. 7 is a side view of only the main body of the embodiment of FIG. 5D, including the pulley, handle, and locking mechanism;

FIG. 8 is a side view of a pressing segment compatible with the main body of FIG. 7 and configured to apply pressure over an extended region of a users' body;

FIG. 9 is a side view of a pressing segment compatible with the main body of FIG. 7 and configured to apply focused pressure to a user's body using a rounded knob;

FIG. 10 is a perspective view from behind of a user applying the assembled embodiment of FIGS. 7 and 9 to an upper rear shoulder area;

FIG. 11 is a side view of a pressing segment compatible with the main body of FIG. 7 and configured for applying gravitational or lower body force to a user's body;

FIG. 12 is a perspective rear view of a user applying the embodiment of FIG. 5C to apply gravitational force to the user's upper back; and

FIG. 13 is a side view of an anchoring accessory included in some embodiments of the present invention.

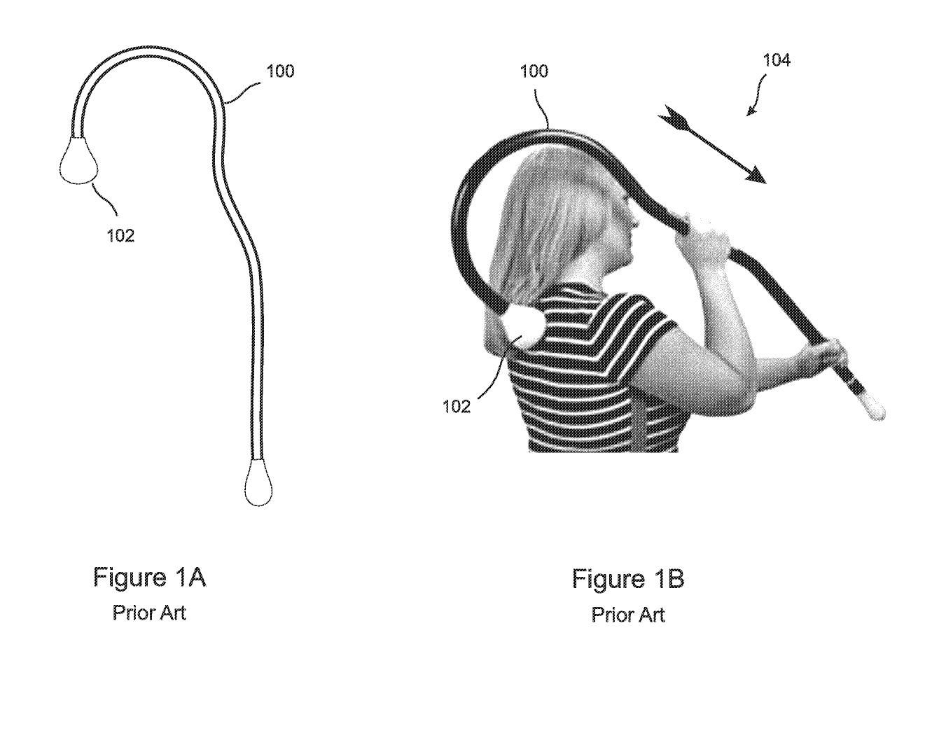

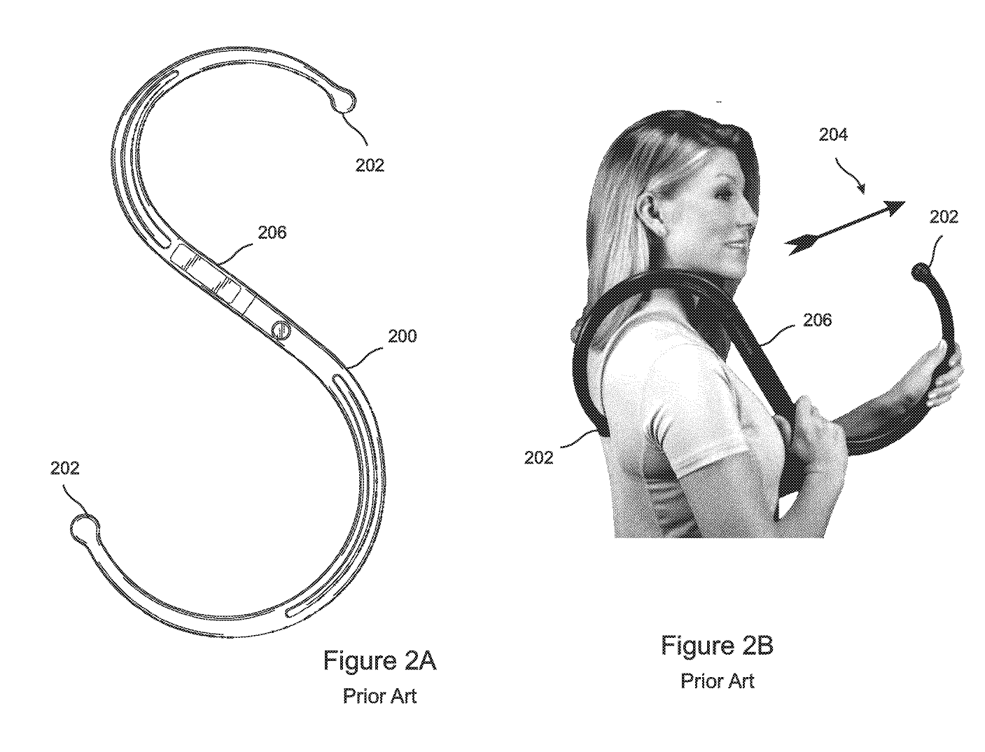

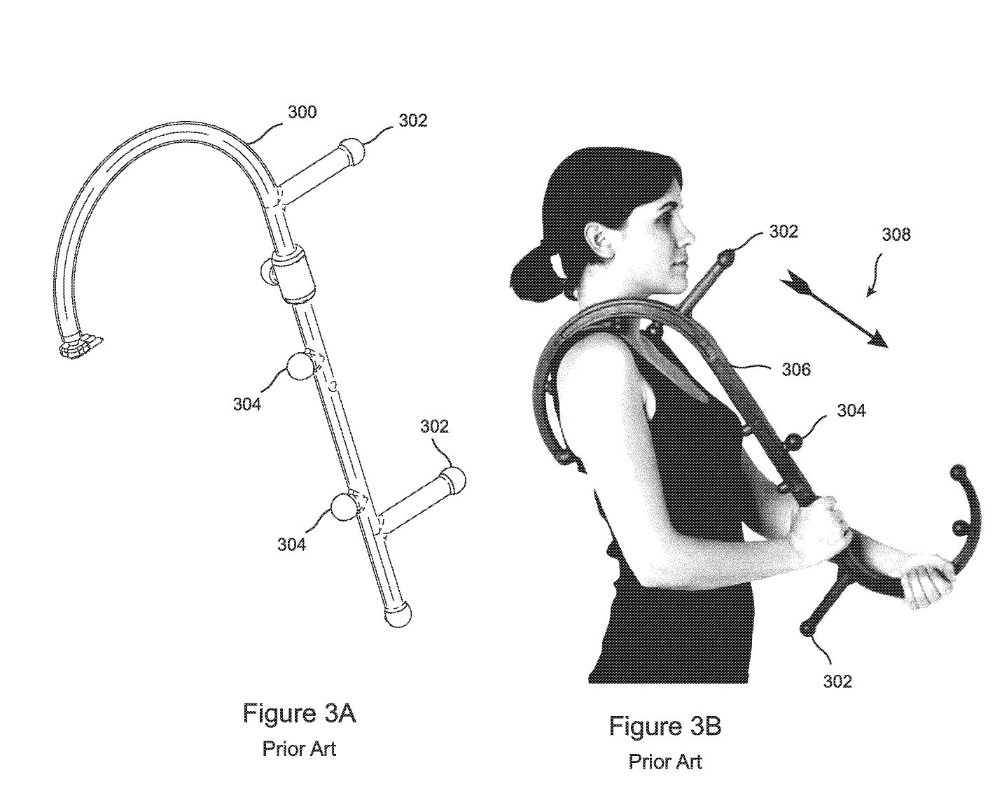

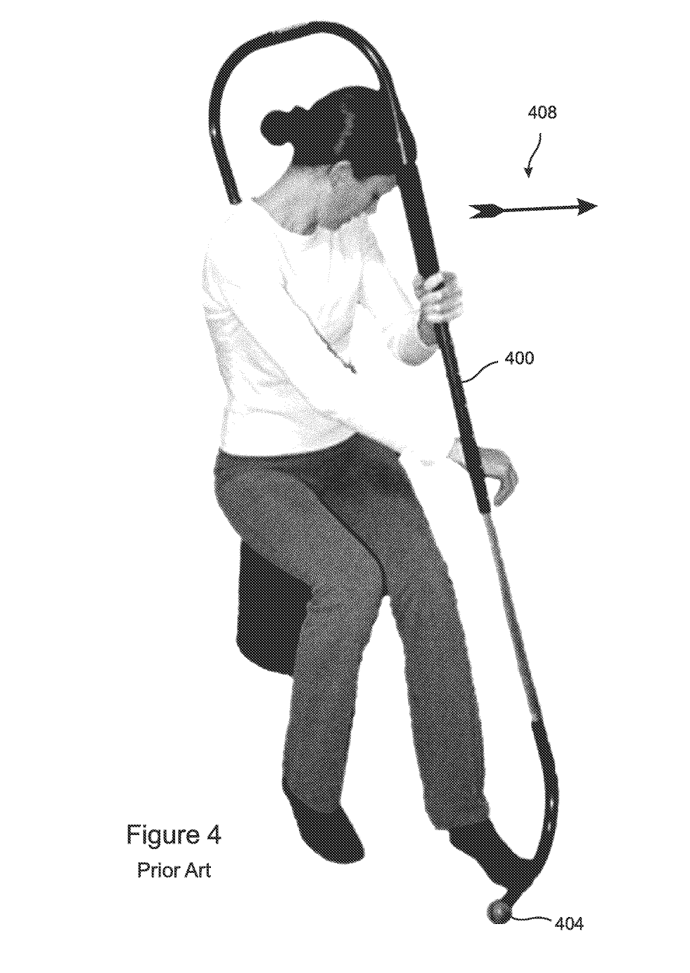

### DETAILED DESCRIPTION

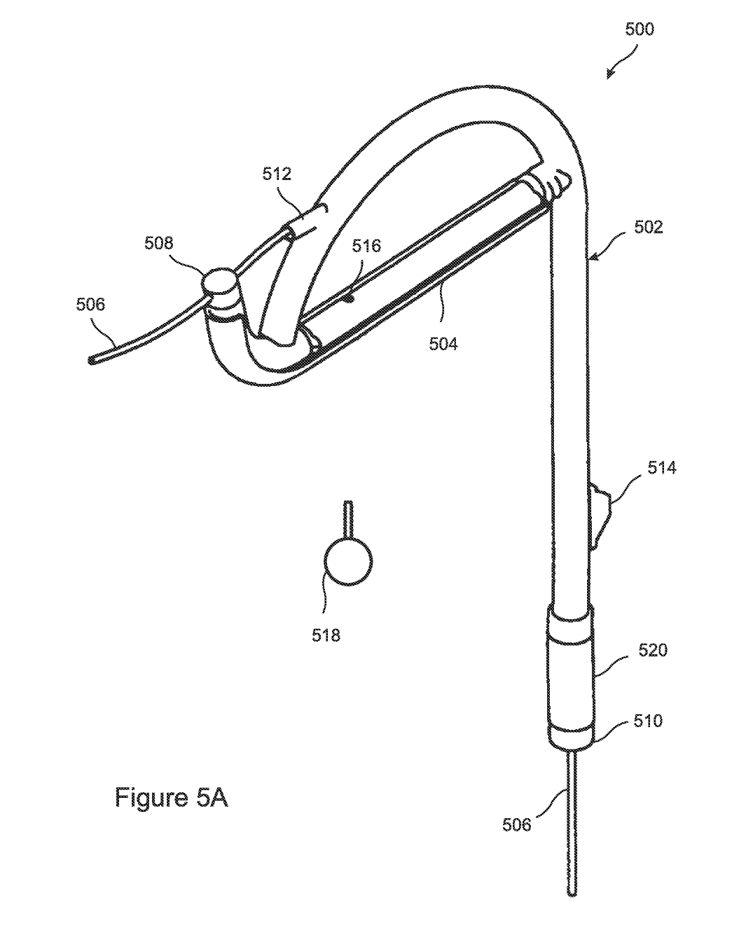

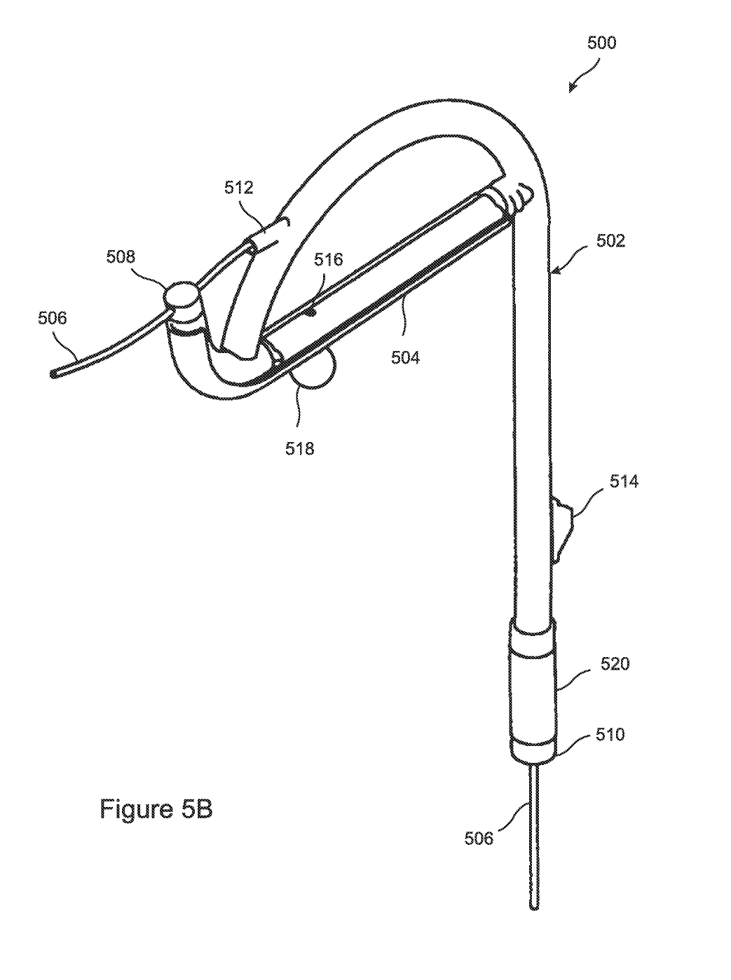

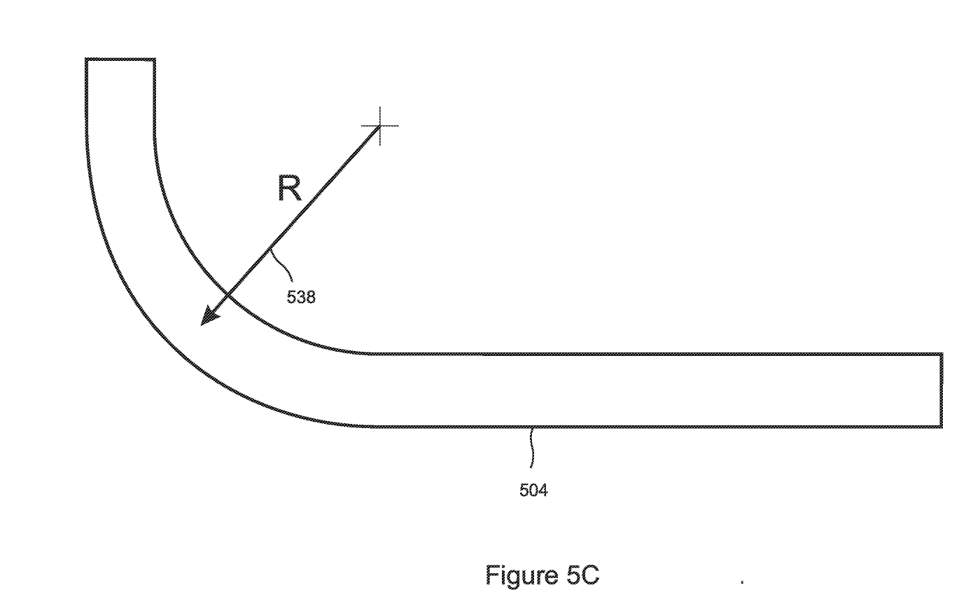

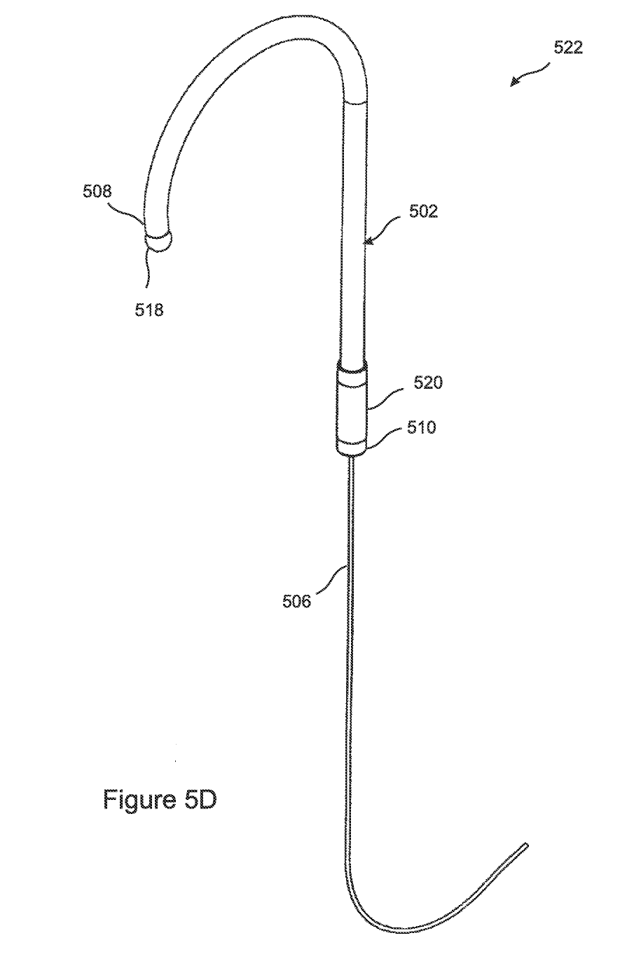

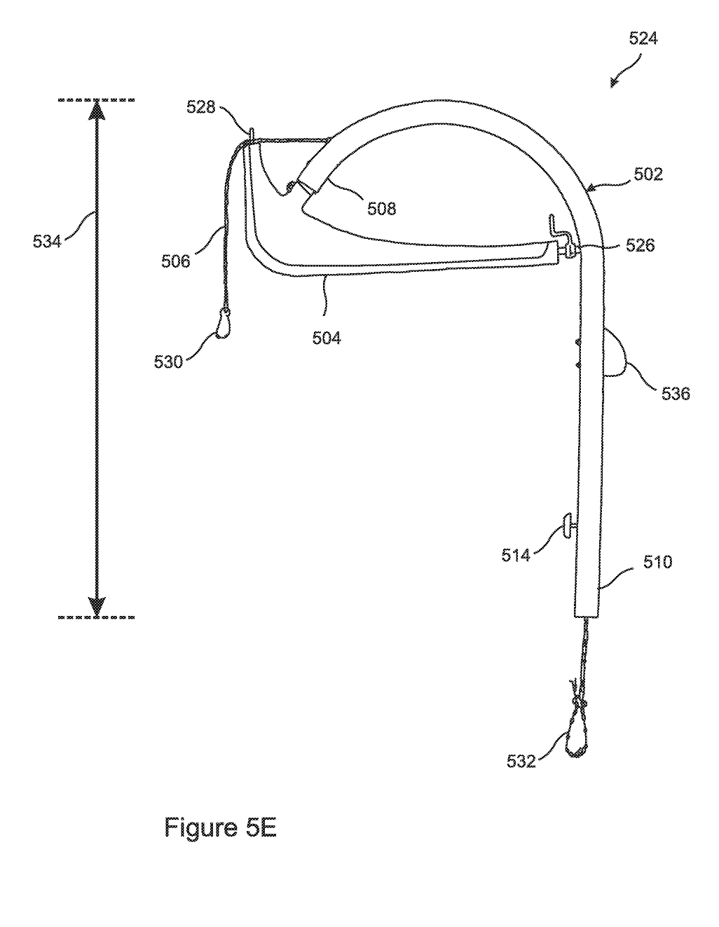

With reference to FIG. 5A, the present invention is a tool 500 for applying deep pressure to trigger points and other distressed muscles. The tool 500 combines a generally hook-shaped main body 502 with a pressing segment 504 and a pulley system 506 to augment a user's physical effort by using leverage and/or gravitational forces to maximize the pressure applied to distressed muscle area while minimizing the amount of effort and strength required from the user.

Depending on the area where the pressure is to be applied, the present invention uses leverage to greatly amplify the user's muscle force, and/or substitutes the user's own weight and the force of gravity in place of muscle strength. In some embodiments, the tool 500 can also enable application of a user's lower body strength, e.g. leg muscles, to affected areas, thereby increasing the available force and decreasing the required effort, because lower body strength is typically much greater than upper body strength.

In embodiments, the hooked portion of the main body 502 is shaped as an arc of a circle with a radius of between 4 and 7 inches. In other embodiments, the hooked portion of the main body 502 has the shape of a partial ellipse with a long axis of between 8 and 14 inches.

Depending on the application, the pulley system 506, 514 of the invention is used to anchor either the proximal end 508 or the distal end 510 of the tool 500 by securing one end of the pulley cord 506, also referred to herein as the “Tension Control Element” 506, either under the user's foot or to a nearby structure, essentially fixing one end of the tool 500 in place. In various embodiments, the tension control element 506 is made from rope, wire cable, plastic cord, and/or chain.

Depending on the embodiment, the Tension Control Element is a rope or a series of knots, chain, nylon strapping, nylon webbing ¼″ to 1″ wide and up to ¼″ thick, or friction binding. In the embodiment of FIG. 5A, the tension control element passes through the center of the main body 502 of the device, while in other embodiments it is anchored to the top, bottom, or side of the device, or woven through the main body 502 from side to side or up and down.

In the embodiment of FIG. 5A, the pressing segment 504, also referred to herein as the “rocker arm,” is permanently attached to the main body 502, which is tubular, and the pulley cord 506 runs through the center of the main body 502 and exits through the distal end 510, and through a port 512 located near the proximal end 508. While the main body 502 and the rocker arm 504 are both tubular in the embodiment of FIG. 5A, in other embodiments these elements take on different shapes, and in general the invention is not limited to tubular elements. For example, the rocker arm 504 in some embodiments is formed from flat metal stock. In some of these embodiments, the thickness of the flat metal stock ranges from ⅛ inch to ½ inch and the width ranges from ¾inch to 4 inches. In certain of these embodiment, the flat metal stock is further shaped so as to have a radius in width (perpendicular to the radius 538), for example a radius in width of between ¾inch and 4 inches, so that the rocker arm 504 approximates a section of a tube.

In the embodiment of FIG. 5A, the pulley cord 506 also passes through a guide hole provided in the proximal end 508, so that forces applied to the proximal end of the pulley cord 506 will be applied to the proximal end 508 of the main body 502. In similar embodiments, the pulley cord 506 is external to the main body 502 and is attached by various means.

Once the proximal or distal end of the pulley cord 506 is secured to the user's foot or to an external structure, a locking mechanism 514 is used to fix the position of the pulley 506 relative to the main body 502. The locking mechanism 514 can include a bolt, a wedge for binding, and/or a friction slide that restricts movement of the Tension Control Element. Depending on the embodiment, the locking mechanism 514 can be made from nylon rope, nylon webbing, hooks, or clamps.

In the embodiment of FIG. 5A, a handle 520 is provided to facilitate grasping of the distal end 510 of the main body 502.

The pressing segment 504 in the embodiment of FIG. 5A includes a mounting hole 516 for mounting of an optional pressing knob 518. With the pressing knob 518 detached, as shown in FIG. 5A, the pressing segment will apply pressure over a wide region of the user's body. If the pressing knob 518 is attached, as shown in FIG. 5B, then the pressure will be applied to a smaller, focused area of the user's body.

The embodiment of FIGS. 5A and 5B is configured mainly for applications where the proximal end of the pulley cord 506 is secured to the user's foot or to an external structure while the user places the pressing segment against the desired area and pulls down on the distal end 510 of the main body 502. In similar embodiments the pulley cord 506 is fixed by adjustable or non-adjustable means to the main body, and extends only from the proximal end or only from the distal end, depending on the intended application.

FIG. 5C is a side view of just the rocker arm 508 of FIGS. 5A and 5B, with the remainder of the tool removed for clarity of illustration. In this embodiment, the rocker arm is curved near the proximal end, with said curvature in embodiments having a radius R 538 that is between one inch and three inches.

FIG. 5D is a perspective view of an embodiment that is configured mainly for augmenting pressing force by applying the user's weight. In this embodiment, the pressing segment is simply a pressing knob 518 attached to the proximal end 508 of the main body 502. The pulley cord 506 is fixed to the main body 502, and extends only from the distal end 510 of the main body 502. Pressure is applied to the desired area by securing the distal end of the pulley cord 506 to an external structure, placing the pressing knob 518 against the desired area, and then leaning away, so that the user's weight causes pressure to be applied.

In various embodiments, the invention is a kit that includes both the embodiment of FIGS. 5A and 5B and the embodiment of FIG. 5D. Other embodiments include only one of these configurations, according to the type of pressure and the area of the body that the user wishes to treat.

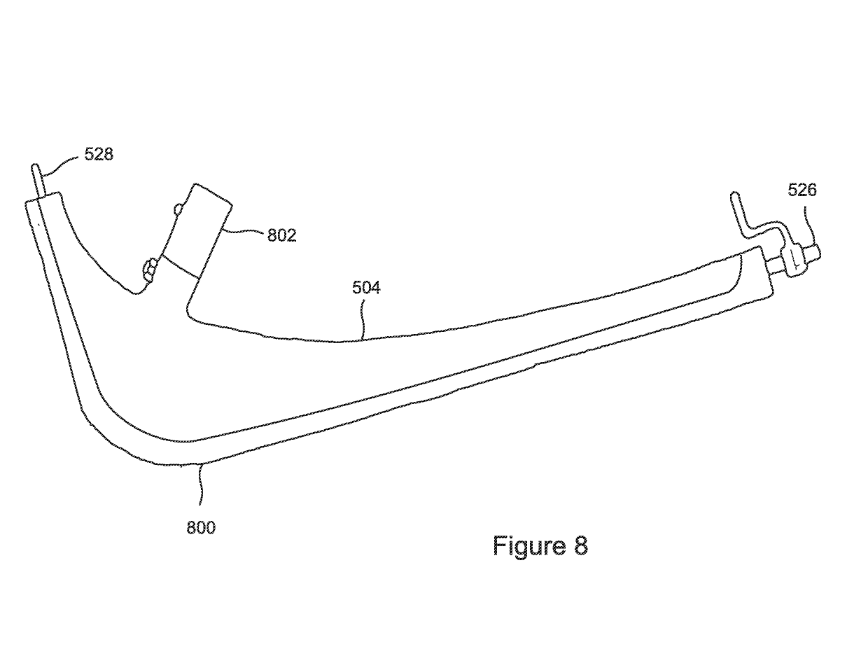

FIG. 5E is a side view of an embodiment that can be used in essentially the same manner as FIGS. 5A and 5B, and then can be reconfigured to function in the manner of FIG. 5D. As in FIGS. 5A and 5B, the pulley cord 506 passes through the main body 502 and exits at the distal end 510 and through a port near the proximal end 508. Unlike FIGS. 5A and 5B, however, the pressing segment 504 in this embodiment is detachable from the main body 502. A tubular adaptor 802 (described in more detail with reference to FIG. 8) extends from the pressing segment 504 and can be inserted into the proximal end 508 of the main body 502, and a spring-loaded bracing mechanism 526 can be inserted into a hole in the main body 502. In this embodiment, the pulley cord 506 emerges from an opening near the proximal end of the main body 502 and passes through a guide 528 that is provided on the removable pressing segment 504.

In the embodiment of FIG. 5E, the pulley cord 506 is terminated at its proximal end by a snap-hook 530, while at the distal end it is terminated by a loop 532. In various embodiments, an overall length 534 of the main body is between 1.5 and 3 feet.

The locking mechanism 514 in the embodiment of FIG. 5E includes a screw-knob that can be tightened against the pulley 506 within the main body 502

In the embodiment of FIG. 5E, a grasping handle 536 is provided on the main body 502 to enable the user 602 to hold and stabilize the main body 502 with one hand while the other hand pulls downward on the distal end 510.

In embodiments, elements of the invention 500 are made from metal tubing, plastic tubing, wood, fiberglass, aircraft strength aluminum tubing, carbon fiber, and/or injection molded plastic. In certain embodiments the main body 518 can be separated into at least two parts for transportation and storage.

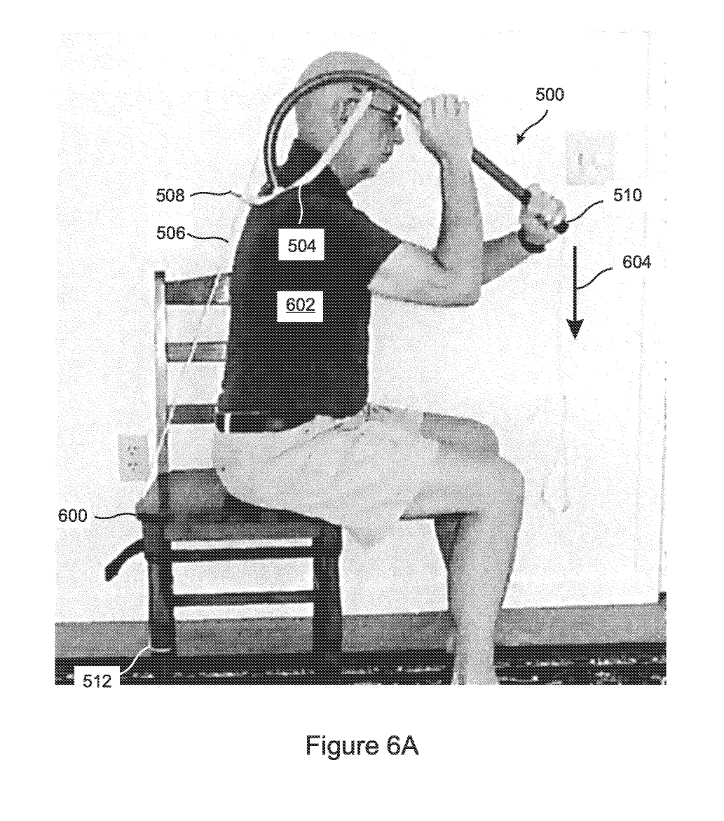

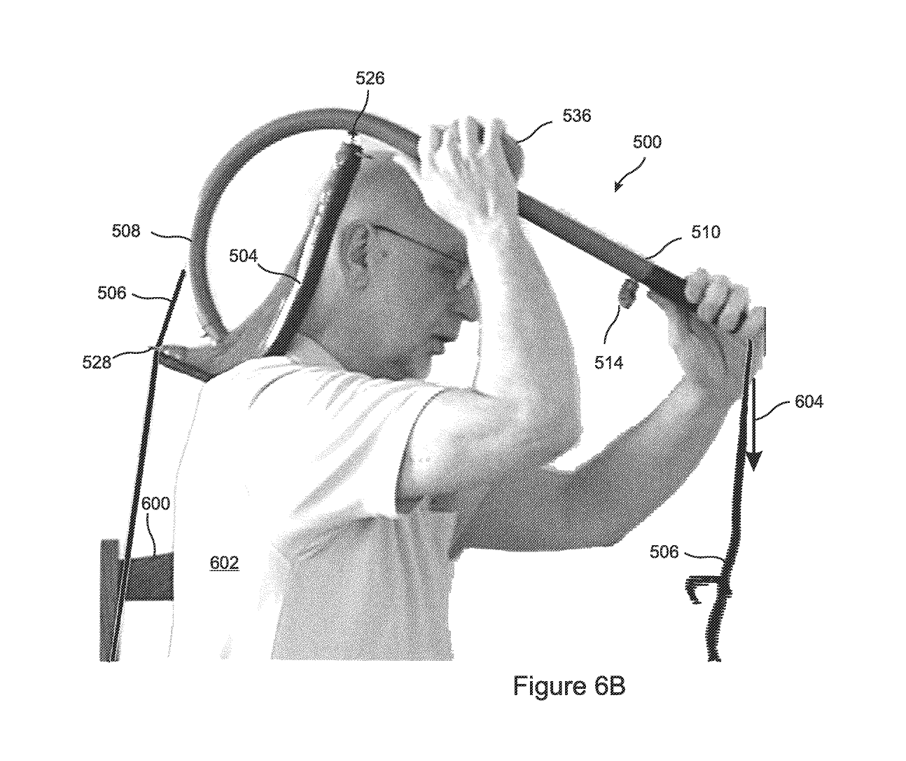

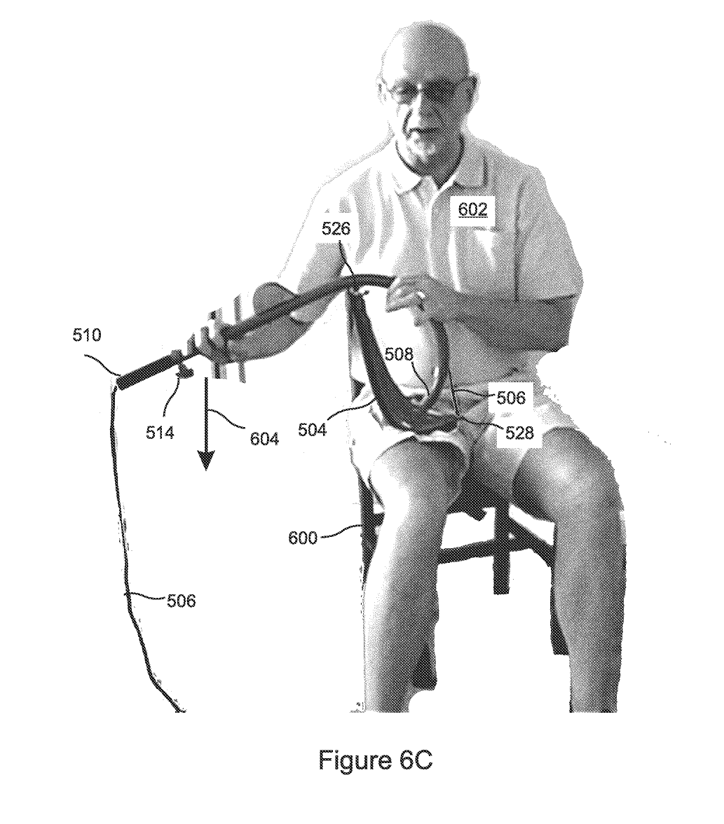

FIG. 6A illustrates how the embodiment of FIG. 5A uses leverage to apply pressure to the upper back or shoulder. The proximal end 506 of the tool 500 is anchored by placing a looped end 512 of the pulley 506 over the leg of a chair 600 that the user 602 is sitting on, and the pressing segment 504 is placed against the distressed muscle area. The user 602 then applies a downward levering force 604 to the distal end 510 of the main body 502, thereby applying pressure to the distressed muscle group with a force that is greatly amplified by leverage as compared to the muscle effort applied by the user 602. FIG. 6B shows the embodiment of FIG. 5C being used in a similar manner.

FIG. 6C illustrates use of the embodiment and configuration of FIG. 5C to apply pressure to a muscle area in a front portion of an upper leg. In this case the pulley is secured to a leg of the chair 600 (hidden by the user's lower leg) and routed under the affected leg, so that it emerges vertically from between the user's legs. As in FIGS. 6A and 6B, the pressing segment 504 is placed against the affected area, which in this case is the top of the user's leg, and the distal end 510 of the tool 500 is pressed downward 604, thereby applying leverage-enhanced pressure to the leg.

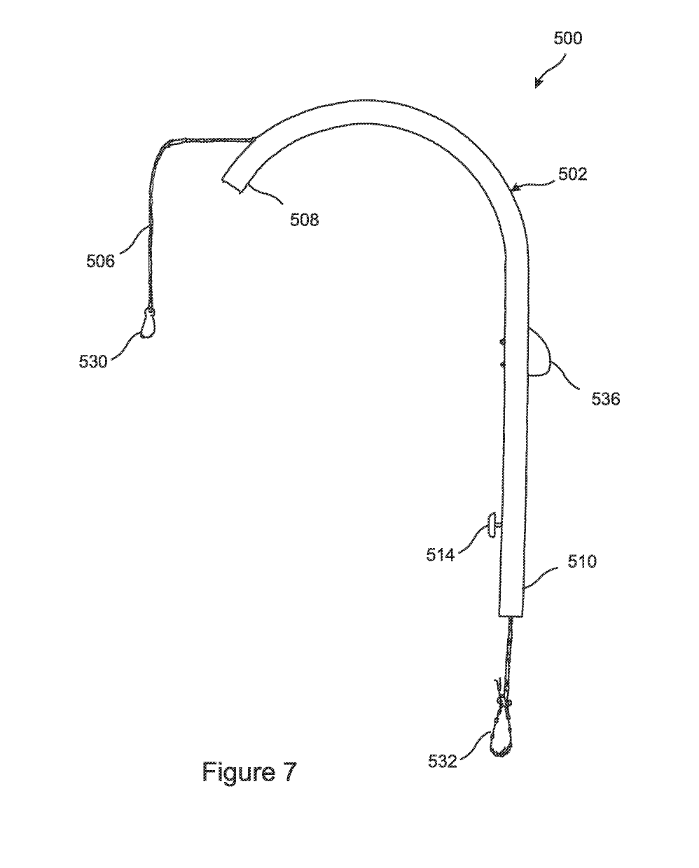

As mentioned above, embodiments of the tool 500 of the present invention include a main body 502 and exchangeable pressing inserts. FIG. 7 is a side view of only the main body 502 of the embodiment of FIG. 5C, including the pulley cord 506, the pulley locking mechanism 514, and the grasping handle 536.

FIG. 8 is a separate side view of the exchangeable pressing segment 504 included in the assembly of FIG. 5C. The illustrated pressing segment 504 includes a pressing area 800 that extends from one end of the segment to the other, smoothly changing in orientation through approximately 90 degrees and thereby providing a smooth, gentle “corner” that is configured for applying pressure over a distributed area of the user's body. The pressing segment 504 includes a tubular adaptor 802 that can mate with the open tubular proximal end 506 of the main body 502.

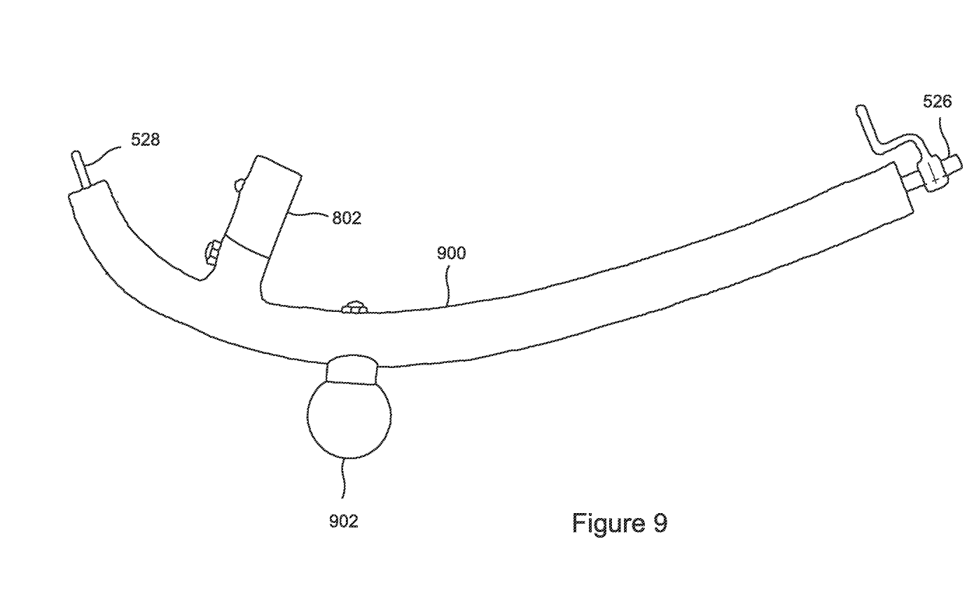

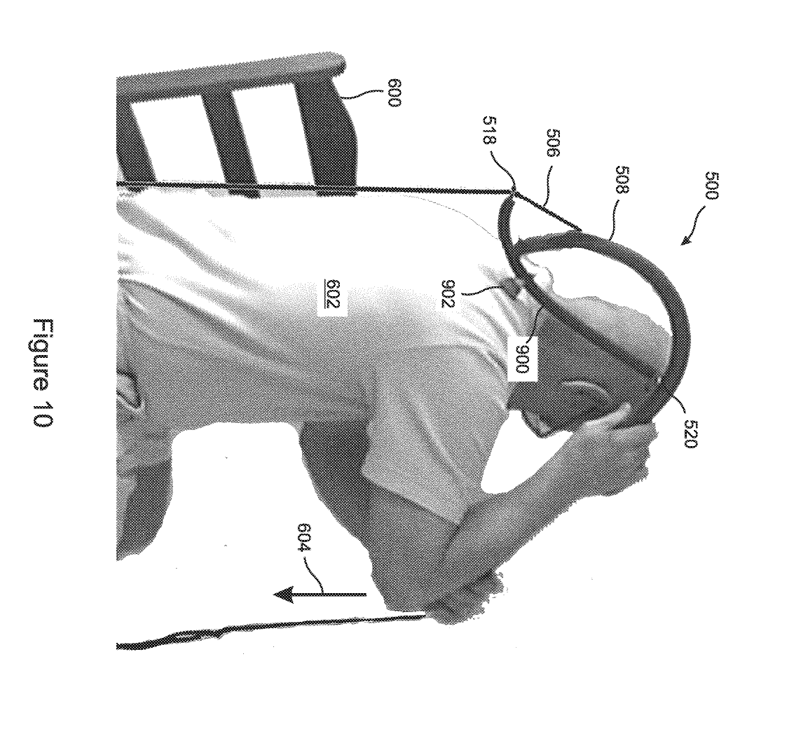

FIG. 9 illustrates an exchangeable pressing segment 900 that is similar to the pressing segment 504 of FIG. 8, except that it includes a pressing knob 902 instead of a more distributed pressing area 800. The pressing segment 900 of FIG. 9 thereby applies leverage-enhanced pressure that is focused on a small area of the user's body.

FIG. 10 is a perspective view of a user 602 applying focused pressure to a shoulder region in a manner similar to FIG. 6B, except that the pressing segment 504 of FIG. 8 has been replaced by the pressing segment 900 of FIG. 9.

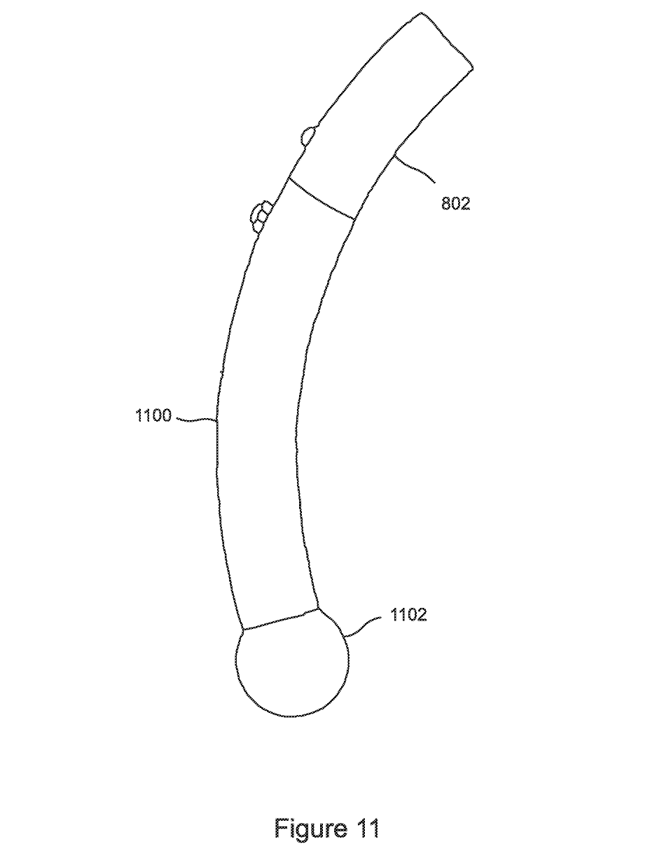

With reference to FIG. 11, in embodiments an exchangeable gravity pressing segment 1100 can be used with the embodiment of FIG. 5D so as to substantially duplicate the configuration of the embodiment of FIG. 5C, and thereby to enable the application of gravitational force to distressed muscles of a user's body. The gravity pressing segment 1100 of FIG. 11 attaches to the proximal end of the main body 502, essentially extending the hook shape of the main body 502, and terminates in a pressing knob 1102.

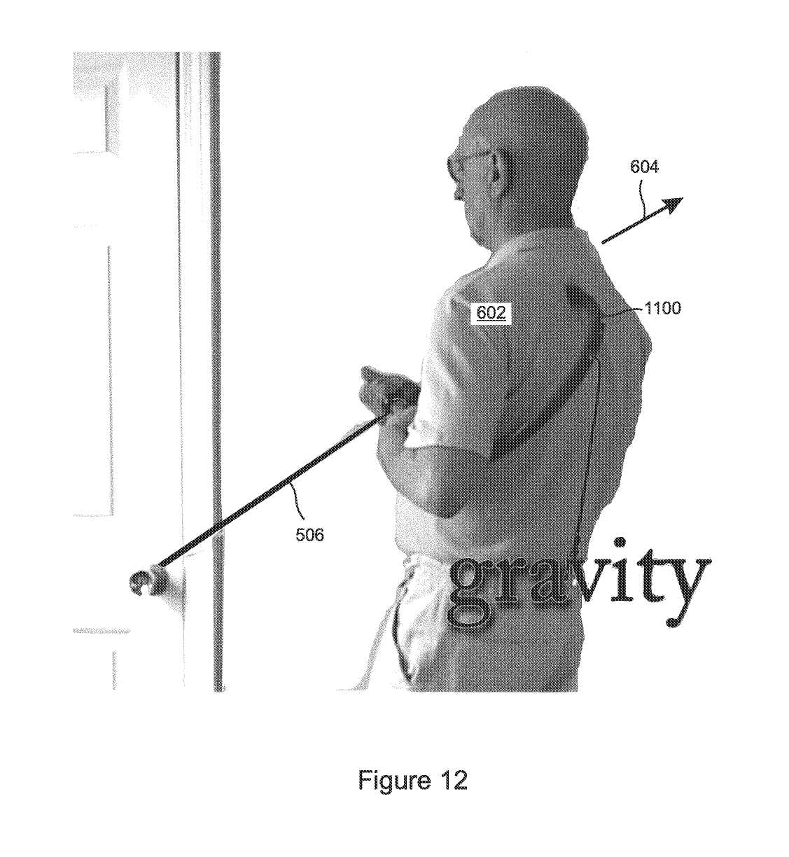

With reference to FIG. 12, when using the embodiment of FIG. 5C or FIG. 11 to apply gravitational force, for example to the lower back, the user 602 anchors the distal end 510 of the main body 502 to a nearby structure (in this case a door knob) using the pulley system 506. The user places the pressing knob 1102 of the gravitational segment 1100 against the distressed muscle group. As shown in FIG. 12, the user 602 then simply leans away from the structure where the pulley 506 is attached, and uses his or her weight to apply gravitational pressure to the desired muscle region.

Depending on the area where the pressure is to be applied, the user 602 can also use the pulley 506 to anchor the distal end 510 of the tool to his or her foot, place the pressing knob 1102 of the gravitational segment against the desired muscle group, for example near the top of a shoulder, and use his or her leg muscles to apply the desired pressure, thereby making use of the significantly greater strength available from leg muscles as compared to arm and shoulder muscles.

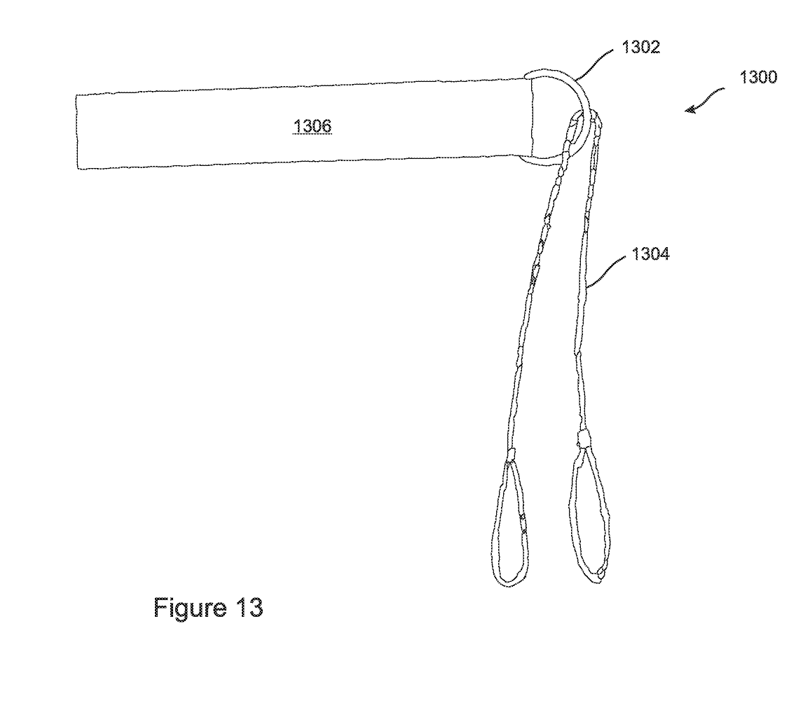

FIG. 13 is a side view of an anchoring accessory 1300 included in some embodiments of the present invention. In this embodiment, the anchoring accessory 1300 includes a metal ring 1302 configured for attachment to the snap fitting 530 that terminates an end of the pulley 506. A short length of cord terminated by a pair of loops 1304 can be used to attach the metal ring 1302 to certain structures, such as a door knob or a leg of a chair. Alternatively, a flat section of nylon webbing 1306 attached to the metal ring 1302 can be placed under the user's foot or under a leg of an article of furniture to anchor the metal ring 1302 and thereby the pulley 506.

In other embodiments, a wedge or a screw is attached to the Tension Control Element 506 (i.e. the pulley cord), whereby a hook is attached to allow a user to attach the Tension Control Element 506 to a nearby structure such as a chair or a stool that the user is sitting on, the hinge of a door or a door knob (e.g. when the individual is in a standing position), or under the user's foot.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A tool for unassisted application by a user of deep pressure to a distressed muscle area of the user's body, the tool comprising:
a main body having a substantially straight section terminating in a distal end and a curved section terminating in a proximal end;
a pulley cord cooperative with the main body and extending beyond at least one of the distal end and the proximal end of the main body, the pulley cord being constrained to remain proximal to the main body at least near one of the main body's distal and proximal ends;
a pulley locking mechanism configured to fix the position of the pulley cord relative to the main body; and
a pressing segment attached to the main body near its proximal end, the pressing segment having a pressing feature,
the main body, pulley cord, pulley locking mechanism, and pressing segment being configured for anchoring by the pulley cord of the distal or the proximal end of the main body to the user's foot or to an external structure and placing the pressing feature against the distressed muscle area, thereby enabling a pressing force to be applied to the distressed muscle area, the pressing force being enhanced by at least one of leverage, gravity, and the user's lower body strength.

2. The tool of claim 1 wherein the main body is separable into at least two parts.

3. The tool of claim 1, wherein at least some portion of the tool is made from metal tubing, flat metal stock, plastic, wood, fiberglass, aircraft strength aluminum, or carbon fiber.

4. The tool of claim 1, wherein the pulley cord includes at least one of rope, wire cable, plastic cord, a series of knots, nylon strapping, nylon rope, nylon webbing, friction binding, chain hooks, and clamps.

5. The tool of claim 1, wherein the pulley cord passes through the center of the main body.

6. The tool of claim 1, wherein the pulley cord is anchored to at least one of a top, a bottom, and a side of the main body.

7. The tool of claim 1, wherein the pulley cord is woven through a handle of the main body from side to side or up and down.

8. The tool of claim 1, further comprising a wedge or a screw attached to the pulley cord, whereby a hook is attached to the pulley cord to allow the user to attach the pulley cord to a portion of the user's body or to a nearby structure.

9. The tool of claim 1, wherein the pulley locking mechanism includes at least one of a bolt, a wedge for binding, and a friction slide that restricts movement of the pulley cord.

10. The tool of claim 1, further comprising a handle attached to the main body, the handle being configured to allow a user to hold and stabilize the main body with one hand while using the tool to apply pressure to the distressed muscle area.

11. The tool of claim 1, wherein the pressing segment includes a mounting mechanism for a removable pressing knob.

12. The tool of claim 1, wherein the pressing segment is removable from the main body and exchangeable with at least one other pressing segment.

13. The tool of claim 12, wherein at least one of the pressing segments is attachable to the proximal end of the main body.

14. The tool of claim 12, wherein at least one of the pressing segments is simultaneously attachable to at least two separated locations on the main body.

15. The tool of claim 12, wherein the pressing feature of at least one of the pressing segments is a region of substantially uniform width extending from a first end of the pressing segment to a second end of the pressing segment and transitioning smoothly in direction there between through an angle of approximately ninety degrees.

16. The tool of claim 12, wherein the pressing feature of at least one of the pressing segments is a rounded knob.

17. The tool of claim 12, wherein at least one of the pressing segments extends from a first end that is attachable to the proximal end of the main body to a second end that is terminated by a rounded pressing knob.

18. The tool of claim 1, wherein at least one end of the pulley cord is terminated by an attachment loop.

19. The tool of claim 1, wherein at least one end of the pulley cord is terminated by an attachment hook.

20. The tool of claim 19, further comprising an anchor assembly including a ring that is attachable to said attachment hook and a flat segment that is attached to said ring and configured for placement under a weighted object for anchoring of the ring thereto.

21. The tool of claim 19, further comprising an anchor assembly including a ring that is attachable to said attachment hook and a cord terminated at both ends by loops, said cord being insertable through said ring and being attachable by said end loops to a compatible structure for anchoring of the ring thereto.
